(19) United States
(12) Patent Application Publication
(10) Pub. No.: US 2012/0145538 A1
(43) Pub. Date: Jun. 14, 2012

(54) METHOD OF INSTALLING OXYGEN-CONSUMING ELECTRODES IN ELECTROCHEMICAL CELLS AND ELECTROCHEMICAL CELL

(75) Inventors: Andreas Bulan, Langenfeld (DE); Rainer Weber, Odenthal (DE); Helmut Lochhaas, Neuotting (DE)

(73) Assignee: Bayer MaterialScience AG, Leverkusen (DE)

(21) Appl. No.: 13/313,760

(22) Filed: Dec. 7, 2011

(30) Foreign Application Priority Data
Dec. 10, 2010 (DE) 102010062803.4

(51) Int. Cl. C25B 9/00; H01M 6/00

(52) U.S. Cl. 204/242; 29/623.1

(57) ABSTRACT

A method for the installation of oxygen-consuming electrodes in electrochemical cells includes sealing one or more oxygen-consuming electrodes in an electrochemical half cell having damaged regions and/or overlap regions and applying a sealing paste. The sealing paste includes silver oxide, a hydrophobic polymer component, and a perfluorinated or partially fluorinated solvent. The method may be used, in particular, for chloralkali electrolysis. An electrochemical cell, having one or more adjoining oxygen-consuming electrodes with damaged and/or overlap regions sealed with a sealing paste having silver oxide, a hydrophobic polymer component, and a fluorinated solvent, is also disclosed.

### CROSS REFERENCE TO RELATED APPLICATIONS

This application claims benefit to German Patent Application No. 10 2010 062 803.4, filed Dec. 10, 2010, which is incorporated herein by reference in its entirety.

### BACKGROUND

1. Field of the Invention

The invention relates to a method of installing an oxygen-consuming electrode in an electrolysis apparatus and an electrolysis apparatus, in particular for use in chloralkali electrolysis, in which damaged regions are sealed with particular sealing pastes.

2. Description of Related Art

Various proposals for operating oxygen-consuming electrodes in electrolysis cells on an industrial scale are known. The basic concept is to replace the hydrogen-evolving cathode of the electrolysis (for example in chloralkali electrolysis) by the oxygen-consuming electrode (cathode). An overview of possible cell designs and solutions may be found in the publication by Moussallem et al., “Chlor-Alkali Electrolysis with Oxygen Depolarized Cathodes: History, Present Status and Future Prospects”, J. Appl. Electrochem. 38 (2008) 1177-1194.

The oxygen-consuming electrode (also referred to herein as “OCE”) has to meet a number of requirements for use in industrial electrolysers. Thus, catalysts and all other materials used have to be chemically stable to sodium hydroxide solution, having a concentration of about 32% by weight, and to pure oxygen at a temperature of typically 80-90° C. Likewise, a high degree of mechanical stability is required for the electrodes to be installed and operated in electrolysers, having a size of usually greater than 2 m² in area (industrial size).

Additional desired properties for the oxygen-consuming electrode include: high electrical conductivity, low layer thickness, high internal surface area and high electrochemical activity of the electrocatalyst. Suitable hydrophobic and hydrophilic pores and an appropriate pore structure for the conduction of gases and electrolytes are also necessary, as are freedom from leaks so that gas space and liquid space remain separated from one another. The long-term stability and low production costs are additional requirements for an industrially usable oxygen-consuming electrode.

Furthermore, the OCE should be able to be installed in the electrolysis apparatus and replaced in a simple manner. Various methods have been described for installation.

For example, U.S. Pat. No. 7,404,878 states that abutting edges of two OCEs are joined using a layer containing perfluorocarboxylic acid, perfluorosulphonyl fluoride or an alkyl perfluorocarboxylate. The layer subsequently has to be joined to the OCEs by means of a heat treatment. The method is difficult to employ since the OCE can be damaged during heat treatment. An additional disadvantage is that the OCE does not operate in the resulting covered and electrochemically inactive edge and overlapping regions. When this occurs, the remaining area is therefore operated at a higher current density, leading to an increase in voltage and thus higher energy consumption.

DE 4444114 A1 describes the installation of an OCE by contacting with the base structure of an electrochemical reaction apparatus by formation of a clamp contact. However, when clamp or press contacts are used, it has been found that the electrical contact resistance thereof frequently deteriorates during the course of operation of the arrangement, which results in an undesirable increase in the consumption of electric energy. A further disadvantage is that the regions of the clamping bars are electrochemically inactive and the OCE area is thus reduced.

A more electrically durable connection between electrodes and electrochemical reaction apparatus can be achieved by means of welding processes, as described in EP 1041176 A1. When a gas diffusion electrode having an unperforated, circumferential, metal margin is used, direct welding to the base structure of the electrode can be carried out. However, the continuous edge mentioned in EP 1041176 A1 of the electrode base structure requires a perforated or slotted metal sheet as support structure. The electrodes to be integrated, therefore, often consist of a metallically conductive base structure which is open-pored over the entire region and in voids of which the electrochemically active composition, hereinafter referred to as coating, is embedded. Attempts to weld the coated electrode directly found on the decomposition of the coating composition usually takes place at high joining temperatures. To achieve a qualitatively defect-free join, coating composition has to be absent in the welding zone. The open-pored base structure of the electrode is therefore free of coating composition in this region. This would allow mixing of the media present on the two sides of the electrode in the electrochemical reaction apparatus during operation without measures for achieving a sealing action.

To avoid mixing of the media, the uncoated welding zone is provided with liquid or paste-like materials which solidify after some time and seal the open-pored structure at this place at the time of application. Solidification of the sealing materials can, for example, be effected by chemical curing of a liquid or paste-like applied substance. Owing to the usually very chemically aggressive conditions prevailing in the electrochemical reaction apparatus, the operating life of the known seals produced in this way has been found to be very short. The operating life thus varies from weeks to a few months, thereby standing in the way of efficient long-term use of the electrochemical reaction apparatus.

Furthermore, the use of a composition which has become plastic as a result of heating and solidifying again on cooling as sealing material has been described in the literature, see EP 1029946 A2. Although chemically inert substances such as PTFE can be used here, a high temperature has to be employed to achieve permanent bonding of this substance with the base structure; according to the teachings of the patent cited, carrying out the processes requires complicated apparatuses/machines.

DE 10152792 A1 describes a method of producing a connection between a gas diffusion electrode and the base structure of an electrochemical reaction apparatus. During use of this method, separation of the media which are present on the front and rear side of the electrode can be ensured by producing an electrically low-ohm join between the margin of the electrode and a metallic fold-like configuration of a circumferential frame which accommodates the margin and the electrically low-ohm connection of the circumferential frame to the base structure of the electrochemical reaction apparatus.

The method according to DE 10152792 A1 is characterized in that the folded part of the frame is made of profiles which are cut in the edge regions for a diagonal joint and are joined to one another by means of laser welding processes or other welding or soldering processes. An overall disadvantage of the method is that the installation measure is very complicated and costly. Replacement of the OCEs is likewise very complicated and cannot be carried out without an appropriate workshop and tools. A further disadvantage affecting the performance is that the folded regions/profiles are electrochemically inactive and an active OCE area is thus lost. The consequence is that the OCE is operated at a higher current density than the counterelectrode (anode), which leads to an increase in the electrolysis voltage and to a deterioration in the economics.

EP1029946 A2 describes a gas diffusion electrode consisting of a reactive layer and a gas diffusion layer and a collector plate, e.g. a silver mesh. The coating does not completely cover the collector plate but leaves a margin which is free of coating. A thin, frame-like metal plate, preferably of silver, is applied to the gas diffusion electrode in such a way that the metallic frame covers a very small area of the electrochemically active coating and a sealing action is also achieved. The frame, projecting beyond the OCE, serves to join the OCE to the electrolysis apparatus, by welding, for example. This contacting is complicated and covers part of the area of the OCE. As a result, the local current density of the free OCE area increases and the performance of the electrolyser drops because of a higher electrolysis voltage. In addition, the complicated installation results in high manufacturing costs for the electrolyser and/or high costs for replacing the OCE.

DE 10330232 A1 describes the installation of an OCE, in which the production of an electrical contact between OCE and electrolysis apparatus and establishment of a seal between gas space and electrolyte space are carried out in one operation. Here, a metallic strip is placed both on the coating-free margin of the OCE and on the catalyst-coated region of the OCE and is joined to the support structure of the electrolysis apparatus by means of laser welding. This process has the disadvantage that the regions of the metallic strip and the weld are electrochemically inactive. This process is very complicated.

Since OCEs are not available in dimensions such that only one OCE has to be installed in each electrolyser apparatus, a plurality of OCEs have to be installed in each electrolysis apparatus. The installation can be affected by slight overlapping of the OCEs or by abutting during installation. Even if a large OCE were available so that one OCE per electrolysis apparatus were able to be installed, regions in which the OCE is creased or defects in the catalytically active component which would have to be sealed are formed as a result of installation. Likewise, damaged places in the catalytically active layer could be present due to incorrect treatment. Separation between gas space and electrolyte space and thus problem-free operation would no longer be ensured at the damaged places.

Given the limitations of the prior art and the lack of methods for sealing any cracks or holes caused by production or use in OCEs, there is a need for methods of installing an oxygen-consuming electrode in an electrolysis apparatus. In addition, there is a need for electrolysis apparatuses, in particular for use in chloralkali electrolysis, in which regions, which may be critical in terms of being gastight, are sealed with particular pastes. The present invention addresses the limitations of the prior art and provides other related advantages, as described in the following summary.

### SUMMARY OF THE INVENTION

The invention provides a novel method for sealing regions of overlap, creased regions, or damaged areas on OCEs caused by installation, including methods of sealing any cracks or holes caused by production or use in OCEs.

Depending on the construction of an electrolysis apparatus, the OCE sometimes has to be conducted around corners, resulting in severe mechanical stress, which acts on the OCE, thereby causing leaks to occur. As described above, leaks lead to an electrolyte being able to get from the electrolyte space into the gas space or a gas being able to get from the gas space into the electrolyte.

Furthermore, the installation of the OCEs in electrolysis apparatuses in which a gas space is separated from an electrolyte space should be such that gas cannot get from the gas space into the electrolyte space and electrolyte cannot get from the electrolyte space into the gas space. The OCE should be leak-free at a pressure differentials between the gas space and the liquid space of 1-170 mbar (hPa). As used herein, leak-free is defined as no visible exit of gas bubbles into the electrolyte space which can be observed. Further, liquid-tight is defined herein as an amount of liquid of not more than 10 g/(h*cm²) passes through the OCE (where g is the mass of liquid, h is an hour and cm² is the geometric electrode surface area).

However, if too much liquid passes through the OCE, this can flow downward only on the side facing the gas side. This can form a liquid film, which prevents entry of gas into the OCE. This film has an extremely adverse effect on the performance of the OCE (undersupply of oxygen). If too much gas gets into the electrolyte space, the gas bubbles have to be able to be discharged from the electrolyte space. In any case, the gas bubbles blind the electrodes and membrane surface, which leads to a shift in the current density and thus in galvanostatic operation of the cell to a local increase in current density and to an undesirable increase in cell voltage over the cell.

Moreover, only a very small electrochemically active area of the gas diffusion electrode should be lost as a result of installation. The installation should be carried out in a technically simpler way. One such way is by overlapping regions or damaged regions of an OCE, being coated, with a paste that includes silver oxide, a hydrophobic polymer component, and a perfluorinated or partially fluorinated solvent.

The invention, therefore, provides a method for the gastight installation of one or more joining oxygen-consuming electrodes in an electrochemical half cell, characterized in that creased regions and/or cracked regions of the oxygen-consuming electrodes and/or overlap regions of adjacent oxygen-consuming electrodes occurring when the oxygen-consuming electrodes are brought into juxtaposition with the frame of the gas compartment of the half cell are sealed with a paste. The paste is hereinafter referred to as sealing paste such as those based on silver oxides, hydrophobic polymer components, and partially fluorinated or perfluorinated solvents.

The novel method can, in particular, be applied to gas diffusion electrodes which contain silver and/or silver oxide as catalytically active component. The invention preferably relates to the installation of gas diffusion electrodes in an electrolysis apparatus in which a gas space is separated from an electrolyte space, in particular, OCEs based on silver. Examples of the production of silver-based OCEs is described, by way of example, in DE 3710168 A1 or EP 115 845 A1. These references also describe the use of catalytically active species present in the form of silver. It is also possible to use OCEs based on catalysts in which silver is supported on carbon.

The sealing paste and/or the oxygen-consuming electrodes are preferably based, independently of one another, on a fluorinated polymer, in particular polytetrafluoroethylene (PTFE), and a silver-containing catalytically active material.

In an another variation of the novel method, the catalytically active component in the sealing paste and/or in the oxygen-consuming electrodes comprises, independently, silver, silver(I) oxide or silver(II) oxide or mixtures of silver and silver oxide.

When carrying out the novel method, the overlap and/or creased regions and/or damaged regions are particularly and preferably located at places in the electrolysis apparatus in which the electrolysis apparatus exerts mechanical force on the regions coated with the paste after assembly.

### BRIEF DESCRIPTION OF THE DRAWINGS

In the figures, the reference numerals are defined as follows:
1, 1a oxygen-consuming electrodes (OCEs)
2 electrochemical half cell
3 frame
4 gas compartment
5 creased region
6 cracked region
7 anode
8 overlap region
9 sealing paste
10 anode half shell with anode 7
11 ion-exchange membrane
12 spacer
13 support structure
14 sealing profile

Numerous other features and advantages of the invention shall become apparent upon reading the following detailed description taken in conjunction with the accompanying drawings, in which:

FIG. 1 shows a schematic cross section through an electrochemical cell in the half-opened state, depicting an overlap region.

FIG. 2 shows a schematic depiction of the covering of two oxygen-consuming electrodes with a sealing paste in an overlap region and the covering of a crack in the oxygen-consuming electrode with a sealing paste.

### DETAILED DESCRIPTION OF THE PREFERRED EMBODIMENTS

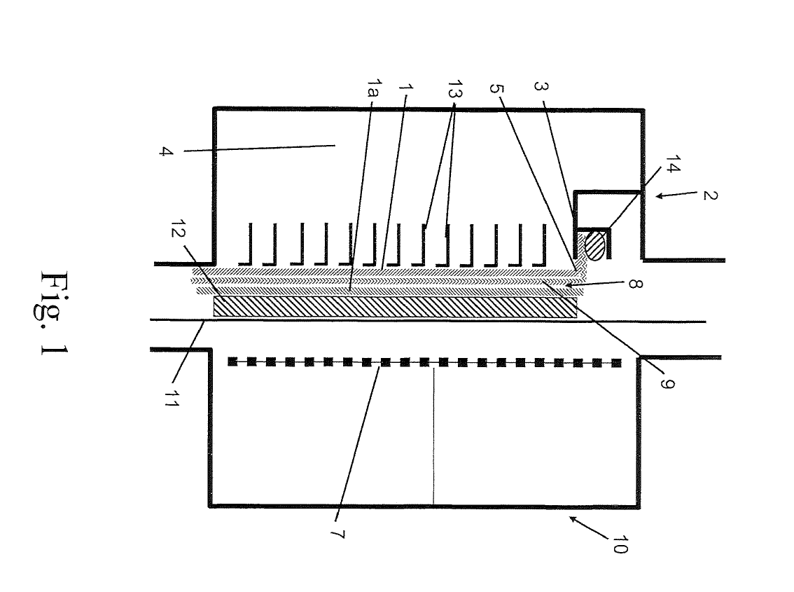

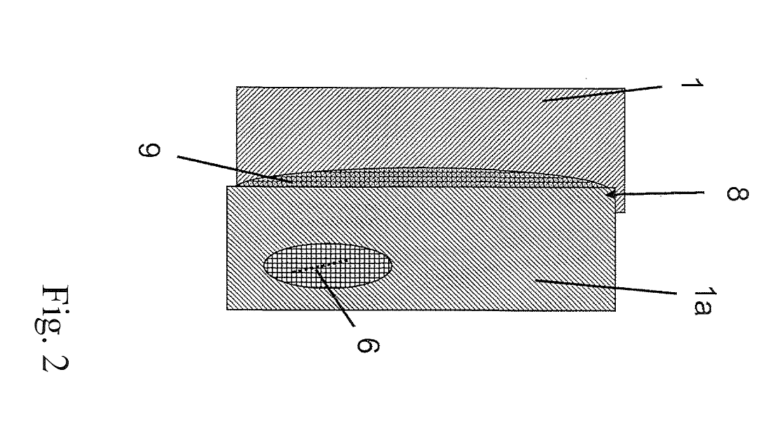

Turning in detail to the drawings, FIGS. 1 and 2 show electrochemical cells, having oxygen-consuming electrodes (OCEs) 1, 1a. FIG. 1, in particular, shows cross-sectional view of electrochemical half cells 2, 10, shown respectively as a cathode half cell 2 having cathodes and an anode half cell 10 having anodes 7. An ion-exchange membrane 11 and spacer 12 may also be positioned between these two half cells. As discussed, the OCEs may be produced with a silver base or derived from catalysts. In this structure, power may be supplied to OCEs 1, 1a via a support structure 13, as further described in the Example below. One half cell also defines a gas compartment 4.

The OCEs 1, 1a are shown in an overlapping arrangement, as defined by an overlap region 8. The OCEs may be further fixed to a frame 3, which may include a sealing profile 14 positioned in a profile edge of a frame, as shown in FIG. 1. A creased region 5 (FIG. 1), cracked region 6 (FIG. 2), or other damaged areas are on OCEs. These types of areas may be caused during installation, production, or use.

A sealing paste 9 is applied to and distributed on damaged regions and/or overlap regions 8 such that these regions 8, 9 are completely covered. The application and distribution of the sealing paste 9 over the damaged regions and/or overlap regions 8 allows for sealing of the creased regions 5 and/or cracked regions 6 of the OCEs 1, 1a, as further described in the Example below.

### Description of Preferred Forms of the Sealing Paste Suitable for the Novel Method:

To produce the sealing paste, silver oxide having the following average diameter: D50: 0.5-50 μm, preferably 1-30 μm, is used, but coarser or finer powders can also be used in principle. The hydrophobic polymer used should be chemically stable under the conditions under which the OCE is used. For example, in chloralkali electrolysis, the polymer should be stable to 32% strength by weight NaOH at 90° C. in the presence of pure oxygen. It is possible to use, for example, fluorinated or partially fluorinated polymers such as polytetrafluoroethylene (PTFE), perfluoroalkoxy (PFA), perfluoroethylene propylene (FEP), ethylene tetrafluoroethylene (ETFE) or polyvinylidene fluoride (PVDF). Furthermore, the polymer should also be largely stable to the oxidizing action of silver oxide, in particular under the conditions of producing the sealing paste.

The polymeric components of the sealing paste preferably comprise PTFE. The sealing paste can consist of silver oxide powder, PTFE power, preferably PTFE and a fluorinated solvent selected from the group consisting of perfluorinated hydrocarbon compounds, for example perfluorinated alkanes or amines, e.g. perfluorooctane or perfluorotriethylamine, or partially fluorinated solvents such as perfluoropolyethers.

The mixing of silver oxide, PTFE and fluorinated/partially fluorinated solvent can preferably be carried out manually, in kneaders or mixers. Likewise, first, the PTFE can be mixed with the fluorinated/partially fluorinated solvent, with the silver oxide then being added to the resulting mixture. It is also possible to first mix silver oxide with PTFE and add the fluorinated/partially fluorinated solvent after the initial mixing process.

In the case of the sealing paste, the proportion of the polymeric component in the mixture with silver oxide is preferably selected so that electrochemical reduction of the silver oxide in the sealing paste can occur under the conditions of operation of the OCE in the electrolysis apparatus. In the preferred method, the proportion of silver oxide in the sealing paste is at least 10% by weight, particularly preferably at least 20% by weight, based on the total weight of the paste. For the polymer, particular preference is given to using polytetrafluoroethylene (PTFE). Particularly, the proportion of hydrophobic polymer component is preferably not more than 60% by weight, and preferably not more than 40% by weight, based on the total weight of the paste.

The fluorinated/partially fluorinated solvent may be selected from the group consisting of perfluorinated, perfluoropolyethers or mixtures of these solvents is added to this mixture. In addition, the fluorinated/partially fluorinated solvent should preferably have a boiling point of less than 200° C.

The proportion of fluorinated/partially fluorinated solvent is preferably not more than 80% by weight, particularly preferably less than 60% by weight. However, the amount of fluorinated/partially fluorinated solvent should be such that a sufficiently spreadable composition is formed. As used herein, sufficiently spreadable means that the sealing paste can be applied to the surface of the OCE, i.e. the side of the OCE facing the electrolyte side or the side facing the gas side. If the proportion of solvent is too low, the sealing paste cannot be applied over the full area. In contrast, if the proportion of solvent is too high, separation of solvent and solid occurs, making application difficult. Moreover, if the proportion of PTFE selected is too small, the sealing paste may become hydrophilic and as a result not adhere sufficiently to the OCE surface or to the rear side.

It is also possible for the silver oxide to be incorporated like a filler into the polymeric component. For example, PTFE according to EP 951500 made by paste extrusion to produce a porous film can subsequently be comminuted to form a powder again. This can occur, for example, by treatment in a mixer with rapidly running striking tools. The powder obtained can then be admixed with the fluorinated/partially fluorinated solvent to prepare the paste according to the invention.

Furthermore, the polymer can be processed with silver oxide in a manner analogous to the mixing process of DE 2941774 and the powder obtained can be subsequently admixed with the fluorinated solvent. The incorporation of the fluorinated/partially fluorinated solvent can be carried out by continuing the mixing process.

### Use of the Sealing Paste:

The sealing paste can preferably be used for sealing overlap regions of OCEs, in particular by applying the paste in a thickness in the range from 0.1 to 1000 μm to one or both sides of the regions to be sealed of the OCE. The regions which have been coated with sealing paste are subsequently placed on top of one another. The reduction of the silver oxide can then be affected, for example, under the operating conditions in the electrolysis apparatus. A further sealing effect is brought about in the overlap region.

In a similar way, defective places in a silver- or silver oxide-containing catalytically active layer can also be repaired and sealed. An advantage of the regions which have been repaired in this way is that they remain partly active for the electrochemical oxygen reduction. As a result, the OCE area is not significantly reduced.

The layer thickness of the oxygen-consuming electrode without sealing paste is typically ranges from 0.1 to 0.8 mm, preferably from 0.2 to 0.7 mm.

The invention further provides an electrochemical half cell. In one embodiment, the half cell has one or more adjoining oxygen-consuming electrodes, characterized in that the oxygen-consuming electrodes have creased regions, and/or cracked regions of the oxygen-consuming electrodes and/or overlap regions of adjacent oxygen-consuming electrodes. The regions may occur on installation on the frame of the gas compartment of the half cell. In addition, these regions are sealed with a sealing paste which is based on at least a silver oxide and a hydrophobic polymer component and a fluorinated solvent.

A preferred electrochemical half cell is characterized in that it contains fluorinated polymers, in particular polytetrafluoroethylene (PTFE), in the gas diffusion layer of the oxygen-consuming electrodes.

Further preference is given to variants of the electrochemical half cell which are obtained by installation of oxygen-consuming electrodes according to one of the above-described novel methods.

The invention also relates to the use of the new electrochemical cell in chloralkli electrolysis, in particular the electrolysis of NaCl.

An embodiment of the invention is further illustrated below, with the aid of the FIGS. 1 and 2, using examples. These examples, however, do not constitute a restriction of the invention.

### EXAMPLE

20 g of PTFE (type TF2053 from Dyneon) and 40 g of perfluoropolyether (type Galden SV90; manufacturer: Solvay Solexis) and 20 g of silver oxide (average particle diameter D₅₀:8 μm) were mixed by means of glass rod until a homogeneous sealing paste was formed. The sealing paste was applied to the surface of the oxygen-consuming electrodes (OCE) and the OCE rear side in the overlap region 8 of two oxygen-consuming electrodes 1, 1a. The oxygen-consuming electrodes 1, 1a were silver-based OCEs, produced as described in EP 115 845 A 1. As an alternative, OCEs based on catalysts in which silver is supported on carbon could likewise be used. The overlap region 8 of the oxygen-consuming electrodes (1) and (1a) was 8 mm. Furthermore, the sealing paste was also applied in the overlap region 8, and the thickness of the sealing paste 9 was about 1 mm.

The sealing action was tested in an electrochemical cell. In the cathode half cell 2, power was supplied to the cathode 1, 1a via a support structure 13 (see FIG. 1). For this purpose, two silver oxide-based oxygen-consuming cathodes 1 and 1a (OCEs) were placed together so that they overlapped and were fixed by means of a sealing profile 14 in a profile edge of the frame 3 (FIG. 1). The above-described silver oxide-based paste 9 was distributed over the overlap region 8 in such a way that the sealing paste 9 completely covered the overlap region 8.

FIG. 2 shows, in a schematic side view corresponding to FIG. 1, the position of the paste 9 and of the OCEs 1 and 1a in the overlap region 8. The anode half cell 10 had an anode 7 made of expanded titanium metal with a noble metal oxide-containing DSA® coating from Denora. Inflow and discharge of the electrolytes and of the gases are not shown in the figures since they are outside the plane of the section. Since the electrolysis cell was operated as a falling film cell, the cathode inlet is located in the upper part of the half cell and the outlet is located at the lower end of the spacer 12. The electrochemical cell was subsequently assembled and started up. The alkali pressure at the lower edge of the cell was 20 mbar. The gas pressure (oxygen) in the gas space 4 was 60 mbar. A sodium chloride-containing solution having a sodium chloride content of 210 g/l served as anolyte and a 30% strength sodium hydroxide solution was used as catholyte. The temperature of the electrolytes was about 85° C., and the current density was 4 kA/m².

A spacer 12 which kept the distance between ion exchange membrane (type Nafion N982WX, manufacturer DuPont) 11 and silver-based oxygen-consuming electrodes 1; 1a constant at 3 mm ran along the overlap region 8. After start-up, no increased gas or liquid breakthrough could be observed. The cell voltage of the cell was in the expected region and was not increased compared to a cell having only one continuous oxygen-consuming cathode without overlap region 8.

The paste 9 also makes it possible to seal, in a manner similar to that described above, creased regions 5 or cracked regions 6 of the oxygen-consuming electrodes 1, 1a occurring at the frame 3 of the gas compartment 4 of the half cell 2, as indicated in FIG. 2.

While embodiments and examples of this invention have been shown and described, it will be apparent to those skilled in the art that many more modifications are possible without departing from the inventive concepts herein. Furthermore, the Examples discussed herein are not to be construed as limiting. As such, the invention is not to be restricted except in the spirit of the following claims.

1. A method of installing oxygen-consuming electrodes in electrochemical cells, comprising:
sealing one or more oxygen-consuming electrodes in an electrochemical half cell having damaged regions and/or overlap regions, by applying a sealing paste, the sealing paste comprising silver oxide, a hydrophobic polymer component, and a perfluorinated or partially fluorinated solvent.

2. The method of claim 1, wherein the silver oxide has an average diameter measuring from 0.5 to 50 μm.

3. The method of claim 1, wherein the silver oxide has an average diameter measuring from 1 to 30 μm.

4. The method of claim 1, wherein the sealing paste comprises a fluorinated or partially fluorinated polymer.

5. The method of claim 1, wherein the sealing paste comprises polytetrafluoroethylene and a silver-containing catalytically active material.

6. The method of claim 5, wherein the catalytically active material comprises silver, silver(I) oxide or silver(II) oxide or mixtures of silver and silver oxide.

7. The method of claim 5, wherein the catalytically active material comprises at least 10% by weight of silver oxide, based on the total weight of the sealing paste.

8. The method of claim 5, wherein the catalytically active material comprises at least 20% by weight of silver oxide, based on the total weight of the sealing paste.

9. The method of claim 1, wherein the one or more oxygen-consuming electrodes comprises polytetrafluoroethylene (PTFE) and a silver-containing catalytically active material.

10. The method of claim 1, wherein the sealing paste comprises mixtures containing a catalytically active component having from 70% to 95% by weight of silver oxide.

11. The method of claim 1, wherein the sealing paste comprises mixtures containing a catalytically active component having from 0% to 15% by weight of silver metal powder.

12. The method of claim 1, wherein the sealing paste comprises mixtures containing a catalytically active component having from 3% to 15% by weight of a fluorinated polymer.

13. The method of claim 12, wherein the fluorinated polymer is polytetrafluoroethylene.

14. The method of claim 1, wherein the one or more oxygen-consuming electrodes comprises polytetrafluoroethylene and a silver-containing catalytically active material.

15. The method of claim 14, wherein the catalytically active material comprises silver, silver(I) oxide or silver(II) oxide or mixtures of silver and silver oxide.

16. The method of claim 14, wherein the catalytically active material comprises at least 10% by weight of silver oxide, based on the total weight of the sealing paste.

17. The method of claim 14, wherein the catalytically active material comprises at least 20% by weight of silver oxide, based on the total weight of the sealing paste.

18. The method of claim 1, wherein the one or more oxygen-consuming electrodes comprises mixtures containing a catalytically active component having from 70% to 95% by weight of silver oxide.

19. The method of claim 1, wherein the one or more oxygen-consuming electrodes comprises mixtures containing a catalytically active component having from 0% to 15% by weight of silver metal powder.

20. The method of claim 1, wherein the one or more oxygen-consuming electrodes comprises mixtures containing a catalytically active component having from 3% to 15% by weight of a fluorinated polymer.

21. The method of claim 12, wherein the fluorinated polymer is polytetrafluoroethylene.

22. The method of claim 1, further comprising pressing the sealing paste and the oxygen-consuming electrodes together after application of the sealing paste.

23. The method of claim 1, wherein the sealing paste has a solvent selected from the group consisting of: perfluorinated hydrocarbons, perfluorooctane, perfluorotriethylamine perfluoropolyethers and mixtures of perfluorinated hydrocarbons and perfluoropolyethers.

24. The method of claim 1, wherein the sealing paste has a proportion of the hydrophobic polymer component of not more than 60% by weight, based on the total weight of the sealing paste.

25. The method of claim 1, wherein the sealing paste has a proportion of the hydrophobic polymer component of not more than 40% by weight, based on the total weight of the sealing paste.

26. The method of claim 1, wherein the sealing paste has a proportion of partially or perfluorinated solvent of not more than 80% by weight, based on the total weight of the sealing paste.

27. The method of claim 1, wherein the sealing paste has a proportion of partially or perfluorinated solvent of not more than 60% by weight, based on the total weight of the sealing paste.

28. The method of claim 1, wherein the sealing paste is applied having a thickness of from 0.1 to 1000 μm to one or both sides of the regions to be sealed.

29. An electrochemical cell, comprising:
one or more adjoining oxygen-consuming electrodes with damaged regions and/or overlap regions sealed with a sealing paste, the sealing paste comprising silver oxide, a hydrophobic polymer component, and a fluorinated solvent.

30. The electrochemical cell of claim 29, wherein the electrochemical half cell is used for chloralkali electrolysis.

31. The electrochemical cell of claim 29, wherein the electrochemical half cell is used for electrolysis of NaCl.
